(19) United States
(12) Patent Application Publication
(10) Pub. No.: US 2014/0260066 A1
(43) Pub. Date: Sep. 18, 2014

(54) STOREFRONT RETROFIT ADAPTER FOR IMPACT GLASS

(71) Applicant: Boris Riglos, Pembroke Pines, FL (US)

(72) Inventor: Boris Riglos, Pembroke Pines, FL (US)

(21) Appl. No.: 14/057,940

(22) Filed: Oct. 18, 2013

Related U.S. Application Data
(60) Provisional application No. 61/800,305, filed on Mar. 15, 2013.

(51) Int. Cl. E06B 1/60; E04B 1/38

(52) U.S. Cl. CPC E06B 1/6015; E04B 1/38
USPC 52/704

(57) ABSTRACT

A NASCA adapter is utilized in combination with an aluminum guide to buttress a mounted storefront frame upon a standard mount. The glass is mounted non-traditionally outside of its normal cavity and instead between the raised portions of the NASCA adapter and the aluminum guide atop its mounting system. Foam tape and silicone sealer are utilized between the raised portions of the adapter and guide to stabilize and lock a pane of glass atop its sitting block. A raised protrusion or installation guide underneath the NASCA adapter acts with the confines of the mounts cavity channel to prevent sideways motion of the glass. The NASCA adapter is locked into the support structure by a concrete screw passing through a hole in the aforementioned; the two members are locked together and to the mount via another screw.

### CROSS REFERENCE TO RELATED APPLICATIONS

This application claims benefit of U.S. Provisional Application No. 61/800,305 filed on Mar. 15, 2013 that is hereby incorporated by reference.

### STATEMENT REGARDING FEDERALLY SPONSORED RESEARCH OR DEVELOPMENT

### N/A

### COPYRIGHT NOTICE

A portion of the disclosure of this patent document contains material that is subject to copyright protection. The copyright owner has no objection to the facsimile reproduction by anyone of the patent document or patent disclosure as it appears in the United States Patent and Trademark Office patent file or records, but otherwise reserves all copyrights whatsoever.

### BACKGROUND

### Field of the Invention

Relating to improvements in device associated with storefront systems; more particularly, relating to improvements in the attachment of the framing of the storefront windows to the surrounding surfaces.

As an example of the prior art, FIG. 1 illustrates a side view of the mounting of a window according to conventional techniques known in the prior art. A piece of tempered glass 1 is mounted on a building wall 8 having the opening using a mount 12 that is attached through the use of silicone 7 or similar adhesives. The tempered glass sits atop a sitting block 5 between two rubber gaskets 2; these gaskets 2 have a protrusion that permits them to sit atop a receiving channel that prevents them from moving therefrom. Finally, a screw 6 is placed in a cavity in the mount 12 through a hole at the bottom surface under the cavity locking the mount to the wall surface 8. Due to modern architecture, displays require the addition of numerous windows that add to the beauty and lighting of structures, the mounting of such to the aforementioned becomes an important construction issue. Thus, windows are an important component in buildings that must be secured against hurricanes. The NASCA adapter 9 permits using the existing framing to accommodate the thicker impact glass without the need to replace the entire storefront. As a result, it saves time with a quick one time installation, and negates the need for maintenance or activation like accordion shutter or hurricane panels. In addition, the NASCA adapter 9 is aesthetically pleasing by negating the need for accordion shutters or panels and is environmentally friendly due to the use existing materials.

### BRIEF SUMMARY OF THE INVENTION

A NASCA adapter 9 is utilized in combination with an aluminum guide to buttress a framing mounted upon a standard mount. The frame is mounted non-traditionally outside of its normal cavity and instead between the raised portions of the NASCA adapter and the aluminum guide atop its mounting system. Foam tape and silicone sealer are utilized between the raised portions of the adapter and guide to stabilize and lock an impact glass or thick glass atop its sitting block.

A raised protrusion or installation guide underneath the NASCA adapter 9 acts with the confines of the mounts cavity channel 4 to prevent sideways motion of the glass. The NASCA adapter 9 is locked into the support structure 8 by a concrete screw 13 passing through a hole in the aforementioned; the two members 9, 10 are locked together to the mount via another screw 11.

In FIGS. 7 and 8, multiple framings are connectable utilizing daisy chained mounts so as to install an entire storefront with the NASCA adapter 9.

### BRIEF DESCRIPTION OF THE SEVERAL VIEWS OF THE DRAWINGS

FIG. 1 illustrates a side view 100 of the mounting of a window according to conventional techniques known in the prior art.

FIG. 2 illustrates a side view of a system figure showing the mounting of a glass using a novel embodiment of the herein disclosed storefront retrofit adapter.

FIG. 3 illustrates a side view of a first and second portion of the storefront retrofit adapter of an embodiment taught herein.

FIG. 4 illustrates a closer view of the installation guide 9′ to be fit into a channel at the underside of the NASCA adapter.

FIG. 5 illustrates the front view of the NASCA adapter 9

FIG. 6 illustrates a top view of the NASCA adapter 9 showing various dimensions.

FIG. 7 illustrates a set of multiple interconnected frames using the adapter taught herein, vertically.

FIG. 8 illustrates a set of multiple interconnected frames using the adapter taught herein, horizontally.

FIG. 9 illustrates an isometric view of the NASCA adapter 9 herein described.

### DETAILED DESCRIPTION OF THE INVENTION

The following is a legend to be used in describing the attached set of drawings.

### Description of Nasca Adapter

1. Existent ¼″ Tempered Glass
2. Existent Rubber Gasket
3. Existent Storefront System
4. Existent channel to receive the gasket
5. Existent Sitting Block
6. Existent Storefront Anchor
7. Existent Silicon sealer
8. Existent Opening
9. NASCA ADAPTER
9′ Installation Guide
10. ¾″×3″×⅛″ Aluminum Angle
11. Hex Washer Head Self Drilling Screw
12. Existent Storefront System
13. Concrete Screw to secure the NASCA Adapter
14. ¼″×½″ Adhesive Foam Tape
15. ¼″ Rubber Sitting Block
16. Silicon Sealer
17. 9/16″ Large Missile Impact Resistance Glass
18. Flat insert nut
19. Machine screw ¼×1½

FIG. 2 illustrates a side view of a system figure showing the mounting of impact glass 17 atop a sitting block 15 using a novel embodiment of the herein disclosed Impact glass retrofit adapter. A structural wall 8 has an opening therein upon which sits an existing mounting system 3; this mounting system is shown having a central cavity for mounting of a glass. Once this cavity is no longer useable or other problems with the mounting prevent its use or make advantageous a retrofitting mount then the instant embodiment is utilized instead. The retrofit adapter system comprises two primary component 9, 10 planar rectangular members to be described with respect to FIG. 3. Both of these portions have a window mounted between the raised portions of the aforementioned; the first portion 9 sits directly above the cavity in the existing mount 3 with a protrusion extending from its underside that enters the channel 4 and has two holes therein one for insertion of a cavity screw and one for the insertion of another screw to lock the two parts 9, 10 together and to the top of mount 3; the other part of the mount is an L shaped aluminum angle 10 having a hole therein.

The glass 17 is buttressed by foam tape 14 on either side and silicone sealer above the foam tape. Thus, the glass is held in place between the two raised sections of the components 9, 10. The two components 9, 10 are made from aluminum, plastic or similar man made materials. The first longitudinal member 9 known as the NASCA Adapter is made from aluminum, hard plastic or similar materials and has a raised portion at its left end in the drawing so that the entire member forms an ‘L’ shape. This raised upper portion forms a clasp or fixture that prevents motion of an adhesively attached glass in the drawing when in use with the aluminum ‘L’ shaped angle 10 and its similarly raised portion.

Turning to FIG. 3 to better understand the portions of the NASCA adapter and how it interacts with the aluminum angle, therein is illustrated a side view of a first 9 and second portion 10 of the impact glass retrofit adapter of an embodiment taught herein. In particular, the member 9 has one linear protrusion or installation guide 9′ shown more clearly with respect to FIG. 4 on its underside in the drawing. Underneath the first member 9 there is a linear protrusion or installation guide 9′ running substantially perpendicularly to the length of the member 9 along the bottom of the member. As these are inserted in the cavity receiving channel 4, they are used to forbid motion of the glass and members sideways in the drawing because they bump up against the channel and inner side of the mount 3. Then, a hole perforates the surface of the planar member 9 so that a concrete screw 13 is inserted therein, through a cavity in the mount 3 having a hole therein about the surfaces of bounding this cavity and then through a hole in the mount and to the side of the wall 8 or structure having an opening therein. Finally, another hole perforates the surface of the planar member 9 further down the length of the member 9 so that a connection can be made with the aluminum angle 10 through a hole in that other member 10 and into the mount 3 thereby securing the portions of the device together with the existing mount 3 and the wall 8 having an opening. The front end of the NASCA adapter has a small portion of the horizontal rectangular member that proceeds beyond the raised portion thereof; the small portion is used to provide mechanical stability on the mount so as to prevent bending and breakage thereof.

The other planar rectangular member 10 is smaller than the first planar rectangular member 9. It too is shaped in a general 1′ shape when having a raised portion at its left side in the drawing so as to hold the other side of a glass 17. This raised upper portion forms a clasp or fixture that prevents motion of an adhesively attached glass 17. Finally, a hole perforates the planar rectangular member 10 in such a fashion that when the member 10 is placed above the member 9 then the second perforation on the member 9 and the only perforation on the member 10 are concentrically located for easy placement of a fastener such as a screw therein and on through the other perforation in the other member. Thus, a screw 11 can be utilized to attach the two members together and to the mount 3 as shown in the drawing.

FIG. 5 illustrates the front view of the NASCA adapter

FIG. 6 illustrates a top view of the NASCA adapter showing various dimensions.

FIG. 7 illustrates a set of multiple interconnected frames using the adapter taught herein. In particular, the implementation shows how a flat insert nut 18 cooperating with a machine screw 19 can hold two adapters 9 together through their respective first perforation when utilized between two interlocking storefront panels vertically.

FIG. 8 illustrates a set of multiple interconnected frames using the adapter taught herein. In particular, the implementation shows how a flat insert nut 18 cooperating with a machine screw 19 can hold two adapters 9 together through their respective first perforation when utilized between two interlocking storefront panels, horizontally (bridge). This view shows a mount in the central part of the drawing using another typical type of mount having different internal structures as shown.

FIG. 9 illustrates an isometric view of the system herein described. In this view, it is clear that there is more than one screw 11 that holds the two members 9, 10 together. As a further expansion of the concept more than one concrete screw 13 holds the NASCA adapter 9 to the mount 12 and ultimately to the wall or support structure 8.

The invention has thus been described in such clear and precise terms as to enable one of ordinary skill in the art to understand its fundamental principles.

I claim:

1. A NASCA adapter for supporting a piece of glass comprising:
a member having
a first raised vertical linear portion on a top surface of the member
a second raised vertical linear portion on a bottom surface of the member and
a first hole in the member between the two raised vertical portions.

2. The Nasca adapter of claim 1, further comprising:
an installation guide.

3. The Nasca adapter of claim 2, wherein the installation guide has a raised vertical linear portion at one end thereof.

4. The Nasca adapter of claim 2, wherein the installation guide has a hole on a top surface thereof.

5. The Nasca adapter of claim 2, wherein the installation guide has a hole on a top surface thereof that matches a second hole concentrically in the member outside of the space between the two raised vertical linear portions and on the side opposite the top surface disposed vertical linear portion.
